(19) United States
(12) Patent Application Publication
(10) Pub. No.: US 2018/0294978 A1
(43) Pub. Date: Oct. 11, 2018

(54) SYSTEMS AND METHODS FOR IDENTIFYING CERTIFICATES

(71) Applicants: Jean L. CAMP, Bloomington, IN (US); Zheng DONG, Bloomington, IN (US); Indiana University Research and Technology Corporation, Indianapolis, IN (US)

(72) Inventors: L. Jean Camp, Bloomington, IN (US); Zheng Dong, Bloomington, IN (US)

(73) Assignee: Indiana University Research and Technology Corporation, Indianapolis, IN (US)

(21) Appl. No.: 15/766,745

(22) PCT Filed: Oct. 17, 2016
(86) PCT No.: PCT/US2016/057378

§ 371 Date: Apr. 6, 2018

Related U.S. Application Data
(60) Provisional application No. 62/243,109, filed on Oct. 18, 2015.

(51) Int. Cl. H04L 9/32; G06F 21/45; G06N 7/00

(52) U.S. Cl. CPC H04L 9/3268; G06N 99/005; G06N 7/005; G06F 21/45

(57) ABSTRACT

A learning certificate authentication system comprising a certificate downloader configured to obtain a certificate, a feature extractor in communication with the certificate downloader that is configured to (i) parse information associated with the certificate and a pattern of use into actionable features and (ii) calculate a value associated with at least one of the actionable features, a classification extractor configured to process the vector with a learning model based on the pattern of use information, a processor, and a non-transitory memory having instructions that, in response to an execution by the processor, cause the processor to calculate a probability of authenticity based on the processed vector are disclosed. Methods of authenticating certificates are also disclosed.

### CROSS-REFERENCE TO RELATED APPLICATIONS

This application claims priority to U.S. Provisional Application Ser. No. 62/243,109, filed on Oct. 18, 2015, the entire disclosure of which is hereby expressly incorporated by reference.

### GOVERNMENT SUPPORT

This invention was made with government support under N66001-12-C-0137 awarded by the Department of Homeland Security. The government has certain rights in the invention.

### FIELD OF THE DISCLOSURE

This disclosure relates systems and methods of authenticating public key certificates. More specifically, this disclosure relates to machine learning or artificial intelligence systems and methods for authenticating public key certificates.

### BACKGROUND

Attacks which leverage the lack of meaningful authentication remain a serious problem that threatens the security and privacy of online users despite long attempts to thwart such attacks. Various exemplary attacks include phishing, pharming, and any attack which leverages trust from a masquerading source. The efficacy of these attacks depends upon the ability of the attacker to confuse the victim into mistaking a malicious source with a trusted one.

For example, phishing websites may display content similar or identical to their legitimate counterparts and replicate the layout and look-and-feel of the legitimate websites. These attacks often start with fraudulent emails sent to a group of online users to lure them to the fraudulent websites, where confidential information is then obtained.

Currently, public key infrastructures have been used to help prevent such attacks. While public key certificates have been a useful tool, they can fail to provide the needed authentication for many organizations, especially small and medium sized organizations.

First, the set of facts embedded in the signature of the public key certificate is sometimes incorrect, either because of changes over time or incorrect issuance. Second, the cryptography (including the digital signature or hash value) could be flawed. Third, the software that is supposed to confirm the authenticity of the certificate can itself be flawed and, thus, the software may authenticate false and incorrect certificates. Fourth, individual end users often perceive that the certificate means something quite different than the intended issuance and implications.

Finally, revocation is an additional challenge for current public key certificates. While some of these certificates may allow for validity periods to be shortened through the use of revocation, revocation itself can present challenges. Two conventional standards for revocation are Certificate Revocation Lists (CRLs) and the Online Certificate Status Protocol (OCSP). However, practices amongst Certificate Authorities (“CAs”) vary, with some issuing certificates with CRL information, some with OCSP, some with both, and some with neither. Even if the CA implements conventional best practices in its certificate issuance, revocation challenges may be further complicated by the irregular behavior of many browsers and web application clients in checking revocation status.

For example, if a browser uses only one standard (e.g., using OCSP exclusively), then all certificates that use another standard (e.g., certificates with only CRL information) effectively become irrevocable. Because the use of some CRL requires a substantial data download compared to the smaller traffic required for OCSP, clients on constrained data connections, such as cellular connections, may also only use OCSP, if any revocation checking is done at all.

Furthermore, mobile applications and other non-browser web clients that use SSL frequently do not check for revocation, thus making it difficult to revoke certificates of servers to which they connect with conventionally.

CAs may also have issued certificates with poorly chosen Extended Key Usages (EKUs). Conventional EKUs typically restrict a certificate to only be used for particular purposes, such as authenticating an SSL server, authenticating a client, signing code, and providing a trusted timestamp. For example, flame malware attacks took advantage of an intermediate CA that had unused but valid Code Signing EKUs, allowing rogue certificates issued from it to be used to sign code. Current risks include that verified signatures may have never been true, may change, and/or no longer be true, or may be technically true, but effectively contain material misinformation. This includes phishing attacks with legitimate certificates, for example when a legitimate server is subverted.

Because conventional solutions for certificates are grounded in problems with the open internet, these conventional solutions are not optimized for small and medium organizations. These organizations need responsive, customized solutions based on the unique institutional view of the Internet, and their own risk tolerance.

A need therefore exists to address issues relating to authentication of certificates, especially for small and medium size organizations.

### SUMMARY

In some embodiments, learning certificate authentication systems may include a certificate downloader configured to obtain a certificate, a feature extractor in communication with the certificate downloader that is configured to (i) parse information associated with the certificate and a pattern of use into actionable features and (ii) calculate a value associated with at least one of the actionable features, a classification extractor configured to process the vector with a learning model based on the pattern of use information, a processor, and a non-transitory memory having instructions that, in response to an execution by the processor, cause the processor to calculate a probability of authenticity based on the processed vector.

In various embodiments, methods of authenticating certificates may comprise obtaining a certificate, parsing information associated with the certificate and a pattern of use into actionable features, calculating a value associated with at least one of the actionable features, storing the values into a vector, processing, by a processor, the vector with a learning model with the pattern of use information, and calculating, by the processor, a probability of authenticity based on the processed vector.

Also, some embodiments may include a non-transitory computer-readable data storage medium comprising instructions that, when executed by a processor, cause the processor to perform acts including obtaining a certificate, parsing information associated with the certificate and a pattern of use into actionable features, calculating a value associated with at least one of the actionable features, storing the values into a vector, processing the vector with a learning model with the pattern of use information, and calculating a probability of authenticity based on the processed vector.

### BRIEF DESCRIPTION OF THE DRAWINGS

The above mentioned and other features and objects of this disclosure, and the manner of attaining them, will become more apparent and the disclosure itself will be better understood by reference to the following description of an embodiment of the disclosure taken in conjunction with the accompanying drawings, wherein:

FIG. 1 illustrates a method of authentication of a certificate according to various embodiments; and

FIG. 2 illustrates a learning certificate system according to various embodiments.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates an embodiments of the disclosure, in various forms, and such exemplifications are not to be construed as limiting the scope of the disclosure in any manner.

### DETAILED DESCRIPTION

The embodiments disclosed below are not intended to be exhaustive or limit the disclosure to the precise form disclosed in the following detailed description. Rather, the embodiments are chosen and described so that others skilled in the art may utilize its teachings.

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

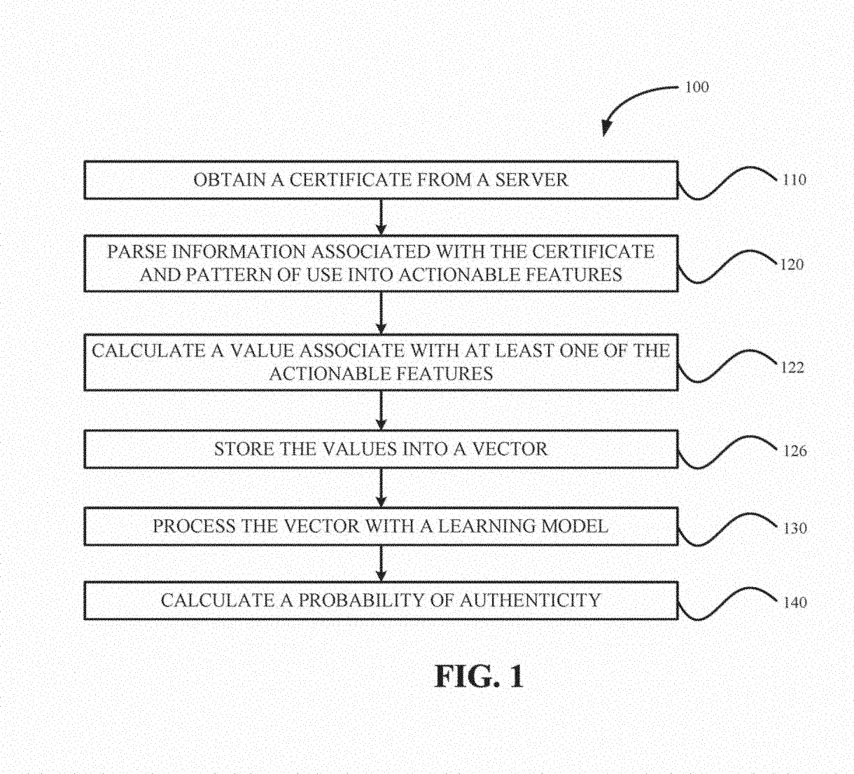

FIG. 1 illustrates a method 100 of authenticating certificates according to various embodiments. Method 100 incorporates machine learning and/or artificial intelligence. Method 100 may include obtaining a certificate (step 110). The step of obtaining a certificate (step 110) is not particularly limited and may include, for example, certificates from websites, certificates from emails, or both. Thus, obtaining a certificate includes pull methods (e.g., “get” methods), push methods, or combinations thereof. Method 100 may also include parsing information associated with the certificate and a pattern of use into actionable features (step 120). The parsing of information associated with the certificate and a pattern of use may include placing the information into an array or plurality of arrays. The information associated with a pattern of use is not particularly limited.

For example, the pattern of use may be based on the web browsing history or email traffic of a single end user, a group of end users, and/or an organization. For example, the pattern of use may include the pattern of use for one individual employee. Furthermore, the pattern of use may incorporate patterns of use throughout a larger demographic, such as a department or office location within an organization. Also, the pattern of use information can be based on the pattern of use of the organization as a whole, across a plurality of organizations, across an industry, or based on global temporal features. Thus, in various embodiments, the telemetry disclosed herein may be integrated with an email server, such as an email server of an organization.

Also, the parsing may be done based on predetermined processing rules. For example, the predetermined processing rules may include using Boolean variables.

Moreover, the pattern of use may account for geographic, temporal, or trend usage in various embodiments of method 100. For example, method 100 may collect, account for, and process with temporal usage information, such as the increased traffic regarding key terms, for example, around a holiday. Thus, while the various methods and systems may account for length of time a certificate has been issued (e.g., a new certificate may be considered more suspicious than an old certificate), various methods may account for increased traffic due to seasonal change or other dynamic usage information.

For example, in winter months, various embodiments of method 100 may include information based on an expected pattern of increased use for winter items, such as snow shovels, jackets, and the like. Moreover, systems and methods disclosed herein may also be able to adapt to geographic and/or temporal usage. Thus, the various systems and methods may be able to account for usage related to snow in temperate zones during winter (e.g., for an organization based in Chicago in the winter) or for usage associated with more mild winters (e.g., for an organization based in Atlanta during the winter where snow does not typically occur).

Method 100 may also include calculating a value associated with at least one of the actionable features (step 122) and storing the values into a vector (step 126).

Method 100 may also include processing, by a processor, the vector with a learning model with the pattern of use information (step 130) and then calculating, by the processor, a probability of authenticity based on the processed vector (step 140).

The learning model is not particularly limited and may include Random Forrest, K-Nearest Neighbors, C4.5, a decision table, a Navie Bayes Tree, Simple Logistic, or combinations thereof. In various embodiments, the learning model may be updated.

The updates to the learning model are not particularly limited and may include push updates (e.g., where a server pushes an update, for example, after a large scale known phishing attack), pull updates (the system may pull updates at programmed intervals, such as weekly), upon request from the user, or a combination thereof. In some embodiments, reduction or elimination of warnings may be desired to help reduce or eliminate warning fatigue.

In various embodiments, the probability of authenticity may be a single final probability after being provided with the detailed classification results. The decision making component (e.g., the processor) may make a final determination and, thus, make a recommendation of a certificate's category. Depending on the personal or organization risk tolerances, the processor may accept the certificate as authentic, may reject the certificate, or may display a warning before allowing an end user to proceed. Thus, end users may customize the policy to support their own decision-making.

In various embodiments, the process may be optimized for the highest true positive rate and the lowest false positive rate. Some organizations, for example, may choose to tolerate many false positives to avoid any risk of a false negative. The processor thus may be configured to allow an organization to make this choice without requiring any understanding of the underlain machine learning mechanisms or factors that inform any authentication determination.

For example, the processor may provide two options for the evaluation of the classification executor output, such as Random Forest and Average Probability. These two algorithms may be complementary in that they provide different false negatives and may be used simultaneously. In various embodiments, Random Forest alone may provide good performance and may have a slight timing advantage over Average Probability, while providing very good receiver operating curves. However, in various embodiments Average Probability may result in fewer false negatives.

Thus, the choice between various options may include an increase in speed and a certainty in avoiding false positives. Various systems and methods may allow for this determination to be made based on the risk tolerance of the user and/or other technical constraints (e.g., on a mobile phone Average Probability may result in user-detectable delay).

Thus, the individual organization (or the user) can choose a different threshold for Random Forest, Average Probability, or a different manner of combining the outputs customized to their own risk posture for authenticating certificates, such as those from a website or email.

Thus, according to various embodiments, method 100 may be used to authenticate a website, and email, or both. Thus, various methods may further include determining the authenticity of the certificate based on the calculated probability of authenticity. For example, an organization may reject all certificates with a calculated probability of authenticity lower than 0.5, whereas a more risk adverse organization may reject all certificates with a calculated probability of authenticity lower than 0.8.

It should be noted however, that the determination is not particularly limited and may be made while considering various factors individually or in combination. Thus, the determination may be based on at least one of a global risk tolerance, a local risk tolerance, or a combination thereof.

Furthermore, the various methods may be incorporated into a set of instructions, such as on a non-transitory computer-readable storage medium comprising instructions that, when executed by a computer, cause a processor, processors, and/or a system to perform the various methods disclosed herein.

For example, the non-transitory computer-readable data storage medium may comprise instructions that, when executed by a processor, cause the processor to perform acts comprising obtaining a certificate, parsing information associated with the certificate and a pattern of use into actionable features, calculating a value associated with at least one of the actionable features, storing the values into a vector, processing the vector with a learning model with the pattern of use information, and calculating a probability of authenticity based on the processed vector.

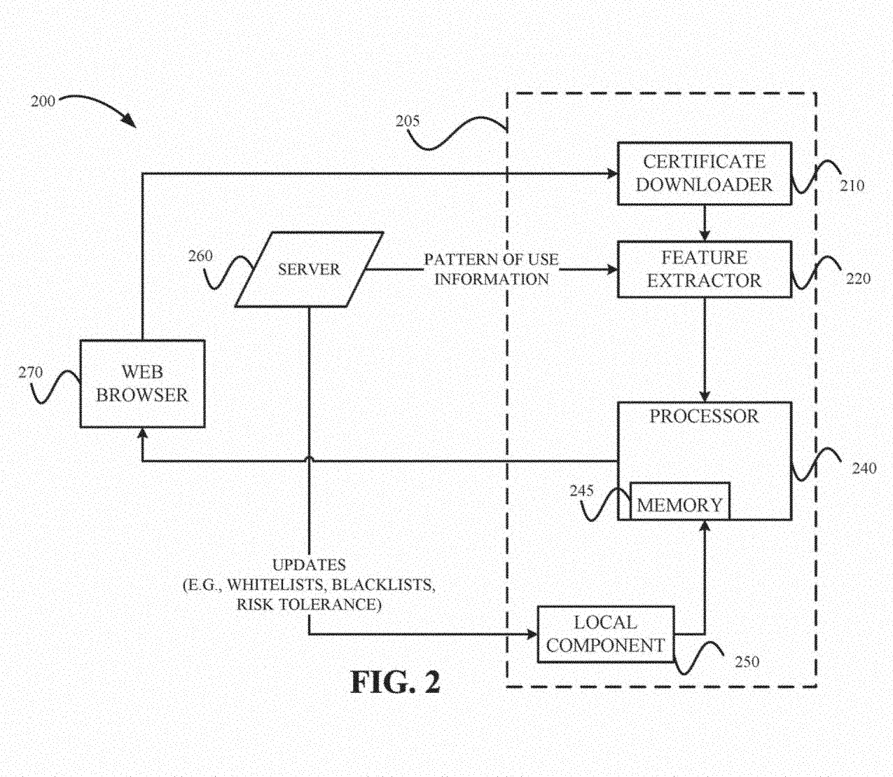

FIG. 2 illustrates a learning certificate authentication system 205 as part of a larger organizational learning system 200 according to various embodiments. Learning certificate authentication system 205 may include a certificate downloader 210 configured to obtain a certificate, a feature extractor 220 in communication with the certificate downloader 210, where the feature extractor 220 is configured to parse information associated with the certificate and a pattern of use into actionable features and calculate a value associated with at least one of the actionable features, a classification extractor 230 configured to process the vector with a learning model based on the pattern of use information, a processor 240, and a non-transitory memory 245 having instructions that, in response to an execution by the processor 240, cause the processor 240 to calculate a probability of authenticity based on the processed vector V.

Learning authentication system 205 may receive certificates from web browser 270. For example, certificate downloader 210 may be configured to receive certificates from a web browser, email, or both. The certificate downloader is not particularly limited and may obtain a certificate from a server in various ways.

Two exemplary ways include either through HTTPS or provided by default when connecting to a specific domain name. With HTTPS the certificate may be provided by default to the browser during connection. If no certificate is provided by default when connecting to the specific domain name, the certificate downloader 210 may be configured to make a separate call to TCP port 443 of a server. The downloaded certificate may be stored in a variety of formats, such as Base-64 format (PEM), with the corresponding domain name and the time of download creating a single record.

In various embodiments, the feature extractor 220 may be in communication with a server 260. The server 260 is not particularly limited an may comprise a central server, for example, the central server for an organization.

The certificate downloader 210 may provide a record (including the certificate and corresponding connection meta-data) to the feature extractor 220. The feature extractor 220 may be configured to parse the downloaded records into a set of actionable features. This may include transforming the data type of many of the certificate fields based on pre-processing rules, for example into Boolean variables. In various embodiments, feature extractor 220 may also be configured to calculated the values for features which are a function of two or more fields in the record provided by the certificate downloader 210. The values for all resulting features may be stored in a vector and may be forwarded to the classification executor 230.

In various embodiments, the feature extractor 220 may provide a vector with various features for processing by the classification executor 230. The classification executor 230 may comprise various machine-learning modules.

The various machine-learning models may be applied to the vector generated by the feature extractor 220 and the classification results of each model. Classification results may be stored in another vector R to support final decision making.

In various embodiments, the processor may calculate probabilities (e.g., the probability of authenticity) and other details. This probability may then be used to determine whether the certificate is authentic or not.

Also, the systems and methods herein may link the authenticating information with a certificate or certificate set and require both the certificate existence in the telemetry and link to a website. This may help prevent web-based spear-phishing attempts, where a company is uniquely targeted. Moreover, the linking may include linking the certificate to a specific passphrase.

The various systems disclosed herein may include a range of algorithms and methods for the challenge of phishing detections. Various embodiments include systems having centralized telemetry systems, which may create a general web-wide mechanism for evaluating certificates. These embodiments may then be made into a series of weighed decisions trees, correlations, and overall voting systems. That simplified deterministic code may then be used in current browser software. In various embodiments, this may be extended to customized, optimized, client-server, learning architectures.

In various embodiments, the centralized telemetry systems may include a centralized server that updates whitelists, blacklists, or both. For example, with continued reference to FIG. 2, the server 260 may be a centralized server that may update a local component (250) of the learning authentication system 205. Local component 250 may be configured to receive updates from a server 260 in communication with the feature extractor 230.

Thus, the server 260 may be configured to aid the processor 240 in determining the authenticity of the certificate based on a customizable risk tolerance. The risk tolerance may be adjusted based on external factors, such as a macro increase in phishing schemes.

As used herein, the term “blacklist’ may be understood to be lists compiled by browser manufacturers, trusted third parties, and social networks of friends identifying fake or compromised certificates. Blacklists exist for different features of malicious sites: IP addresses (e.g., Spamhaus), domain names (e.g., PHISHTANK® a registered trademark of OpenDNS, Inc., a Delaware corporation), and certificates (e.g., CRLs).

As used herein, the term “whitelist” may include a list or register of entities that are being provided a particular privilege, service, mobility, access or recognition. Entities on the list may be accepted, approved and/or recognized with a lower risk tolerance. In other words, whitelisting is the reverse of blacklisting, the practice of identifying entities that are denied, unrecognized, or ostracized. Accordingly, the risk tolerance of an organization may vary by types and classification of certificates (e.g., presence on a whitelist).

In this way, the authentication of the remote site may be a function of two third-parties: the CA which issued the certificate and the whitelist provider who vouches for the certificate. For example, the Electronic Frontier Foundation (EFF) has constructed a large certificate observatory by actively scanning the IPv4 address space. End users can benefit from the observatory by installing a browser extension and submit their observed certificates through the extension. Warnings will be generated when the submitted certificates are inconsistent with the observatory.

Accordingly, various systems may be used to select risk tolerance from both local evaluations, global evaluations or any combination thereof. For example, a global evaluation might include the analysis of whether a website has previously been subverted. The server may be configured to build the decision making components that inform the clients, locally, of which actions to take based on the connection evaluation.

Thus, systems may be configured to not only send browsing history, but may also be configured to accept updates from a single known server to update the instructions stored on memory 245 that are executed by the processor 240 locally. Thus, while various methods implemented by some systems disclosed herein may require intensive processing to initially design or initially implement for an end user or organization, once employed these systems and methods may become extremely fast, because they can be implemented as weighted trees. Thus, as clients will receive updated packages at regular intervals from the server, they may also receive real time instructions on how to respond accordingly.

Moreover, in various embodiments, the feature extractor 220, may include local history information. Incorporating local history information, such variables as breadth and history of use may become embedded in the feature extractor 220. Thus, in various embodiments, the feature extractor 220 may become a data compilation for the single organization that compiles these into a training database which informs the processor 240. Accordingly, while the training database and delay may be initially longer, updates can be done more frequently.

So, according to some embodiments, supervised learning may be used. In other words, machine learning may occur with the use of pre-existing identified categories and some ground-truth knowledge.

For example, in one embodiment, after supervised learning models were built from training data, which took advantage of the ground-truth knowledge, data that was not used in training may then be used to evaluate the performance of the trained models. After training and testing, these models were used to classify new instances into the pre-defined categories. In terms of phishing detection, the machine-learning approaches distinguished between phishing websites and non-phishing websites based on the results of training using all machine-learning features.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described with the benefit of this disclosure. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A learning certificate authentication system comprising:
a certificate downloader configured to obtain a certificate;
a feature extractor in communication with the certificate downloader that is configured to
(i) parse information associated with the certificate and a pattern of use into actionable features; and
(ii) calculate a value associated with at least one of the actionable features;
a classification extractor configured to process a vector with a learning model based on the pattern of use information;
a processor; and
a non-transitory memory having instructions that, in response to an execution by the processor, cause the processor to calculate a probability of authenticity based on the processed vector.

2. The system of claim 1, wherein the learning model comprises at least one of: Random Forrest, K-Nearest Neighbors, C4.5, a decision table, a Navie Bayes Tree, and Simple Logistic.

3. The system of claim 1, wherein the instructions on the non-transitory memory comprise at least one of: a Random Forrest algorithm and an average probability.

4. The system of claim 1, wherein the system is configured to determine the authenticity of at least one of: a website and an email.

5. The system of claim 1, wherein the system is configured to determine the authenticity of the certificate based on a customizable risk tolerance.

6. The system of claim 1, wherein the learning model comprises a local component.

7. The system of claim 6, wherein the local component is configured to receive updates from a server in communication with the feature extractor.

8. The system of claim 7, wherein the server is configured to aid the processor in determining the authenticity of the certificate based on a customizable risk tolerance.

9. A method of authenticating one or more certificates comprising:
obtaining a certificate;
parsing information associated with the certificate and a pattern of use into actionable features;
calculating a value associated with at least one of the actionable features;
storing the value into a vector;
processing, by a processor, the vector with a learning model with the pattern of use information; and
calculating, by the processor, a probability of authenticity based on the processed vector.

10. The method of claim 9, wherein the learning model comprises at least one of: Random Forrest, K-Nearest Neighbors, C4.5, a decision table, a Navie Bayes Tree, and Simple Logistic.

11. The method of claim 9, wherein the calculating the probability of authenticity comprises applying at least one of: a Random Forrest algorithm and an average probability.

12. The method of claim 9, wherein the parsing is done based on one or more predetermined processing rules.

13. The method of claim 12, wherein the one or more predetermined processing rules comprise Boolean variables.

14. A method of determining the authenticity of a website, comprising the method of claim 9.

15. A method of determining the authenticity of an email, comprising the method of claim 9.

16. The method of claim 9, wherein the learning model is updated with at least one of: a push update and a pull update.

17. The method of claim 9, further comprising determining the authenticity of the certificate based on the calculated probability of authenticity.

18. The method of claim 17, wherein the determination is based on the at least one of: a global risk tolerance and a local risk tolerance.

19. The method of claim 9, further comprising linking the information associated with the certificate and requiring both the certificate existence in a telemetry and a link to a website.

20. A non-transitory computer-readable data storage medium comprising instructions that, when executed by a processor, cause the processor to perform acts comprising:
obtaining a certificate;
parsing information associated with the certificate and a pattern of use into actionable features;
calculating a value associated with at least one of the actionable features;
storing the value into a vector;
processing the vector with a learning model with the pattern of use information; and
calculating a probability of authenticity based on the processed vector.

21. The non-transitory computer-readable data storage medium of claim 20, wherein the learning model comprises at least one of: Random Forrest, K-Nearest Neighbors, C4.5, a decision table, a Navie Bayes Tree, and Simple Logistic.
